(19) United States
(12) Patent Application Publication
(10) Pub. No.: US 2025/0070677 A1
(43) Pub. Date: Feb. 27, 2025

(54) ISOLATED DC POWER SUPPLY BASED ON CLASS-E INVERTER AND ITS DESIGN METHOD

(71) Applicant: CHONGQING UNIVERSITY, Chongqing (CN)

(72) Inventors: Jianyu PAN, Chongqing (CN); Sheng YAN, Chongqing (CN); Hong LEI, Chongqing (CN)

(73) Assignee: CHONGQING UNIVERSITY, Chongqing (CN)

(21) Appl. No.: 18/663,129

(22) Filed: May 14, 2024

(30) Foreign Application Priority Data
Aug. 22, 2023 (CN) 202311059345.X

(51) Int. Cl. H02M 3/335

(52) U.S. Cl. CPC H02M 3/33523

(57) ABSTRACT

The invention relates to an isolated DC power supply utilizing a Class-E inverter and its design method, within the field of power electronics and high voltage technology. This DC power supply comprises a DC power source, a Class-E inverter, a CL network, a series resonant unit, and a rectifier circuit, featuring two structures. It is characterized by a single switching device and a stable output voltage that does not vary with load changes. This resolves stability issues commonly associated with isolated DC power supplies based on Class-E inverters. The invention also introduces a design method that includes calculating core parameters like capacitors and inductors, ensuring optimal component selection. Offering strong isolation, constant voltage output, high efficiency, and cost-effectiveness, this DC power supply is ideal for use in wireless power transfer systems, high-frequency power supplies, and isolated sensor and gate driver power supplies.

### TECHNICAL FIELD

The present invention belongs to the field of power electronics and high voltage technology, and specifically to an isolated DC power supply based on Class-E inverter and its design method.

### BACKGROUND ART

The DC power supply structure and design method with low cost, high efficiency, and high-power density are indispensable in scenarios such as wireless power transfer systems, high-frequency AC or DC power supply, isolated sensor, or gate driver power supply. However, the traditional technical scheme using full-bridge inverters or half-bridge inverters increases the cost and volume due to the use of too many switching devices, which is not conducive to the construction of a high-performance isolated DC power supply. The Class-E inverter based isolated DC power supply uses only one switching device, which has the advantages of high frequency and soft-switching, and has good potential for high efficiency and high-power density.

However, the conventional Class-E inverter based isolated DC power supply can only work stably under a single condition, and there are problems of large inductor value/volume and extremely sensitive to load variation. When the load or output power changes, the original stable transmission state will be broken, resulting in over-current, over-voltage, or even burn-out faults of devices, which will eventually make it difficult for Class-E inverters to be applied in high-frequency and high-efficiency DC power supplies. Therefore, there is an urgent need to optimize the design of Class-E inverter based isolated DC power supply.

### SUMMARY

In view of this, the objective of the present invention is to provide an isolated DC power supply based on Class-E inverter and its design method. The present invention aims to solve the problems of single condition and poor stability of Class-E inverter based isolated DC power supply.

In order to achieve the above objective, the present invention provides an isolated DC power supply based on Class-E inverter, including a DC power supply, a Class-E inverter, a CL network, a series resonant unit, and a rectifier circuit, and it has two structures.

The Class-E inverter includes an input inductor Lₑ, a power switching device S, and a parallel capacitor C₀;
the CL network includes a network inductor Lᵣ and a network capacitor Cᵣ;
the series resonant unit includes a transmitting inductor L_{T}, a transmitting capacitor C_{T}, a transmitting inductor parasitic resistance R₁, a receiving inductor L_{R}, a receiving capacitor C_{R}, a receiving inductor parasitic resistance R₂, and M is a mutual inductor between the transmitting inductor L_{T} and the receiving inductor L_{R};
the rectifier circuit includes a rectifier circuit and a filter capacitor Cₒᵤₜ, and the rectifier circuit can rectify the high-frequency AC to the DC required by the load; the two structures include:
Structure I: an input port of the Class-E inverter is connected to the DC power supply, an output port of the Class-E inverter is connected to an input port of the CL network, an output port of the CL network is connected to an input port of the series resonant unit, an output port of the series resonant unit is connected to an input port of the rectifier circuit, an output port of the rectifier circuit is connected to a load;
Structure II: an input port of the Class-E inverter is connected to the DC power supply, an output port of the Class-E inverter is connected to an input port of the series resonant unit, an output port of the series resonant unit is connected to an input port of the CL network, an output port of the CL network is connected to an input port of the rectifier circuit, an output port of the rectifier circuit is connected to a load.

Further, the value of the input inductor Lₑ is 1 nH-500 μH.

Further, the Class-E inverter can invert the DC into the high-frequency AC with constant voltage output, and its transformation ratio can be calculated by Formula (1):

$$\frac{{V}_{E}}{{V}_{in}} = 1.124 \qquad ( 1 )$$

where Vᵢₙ is a voltage of an input DC power supply, and V_{E} is an effective value of an output high-frequency AC.

Further, depending on the different structure, the CL network or the series resonant unit can convert the high-frequency AC with a constant voltage output of the Class-E inverter into a constant current output, and transformation ratio of Structure I can be calculated by Formula (2), transformation ratio of Structure II can be calculated by Formula (3):

$$\frac{{I}_{cc}}{{V}_{E}} = \frac{1}{ω {L}_{r}} \qquad ( 2 )$$

$$\frac{{I}_{cc}}{{V}_{E}} = \frac{1}{ω M} \qquad ( 3 )$$

where I_{cc} is an effective value of a high-frequency output current, ω is an operating angular frequency.

Further, depending on the different structure, series resonant unit or the CL network can convert the constant current input into a constant voltage output, and transformation ratio of Structure I can be calculated by Formula (4), transformation ratio of Structure II can be calculated by Formula (5):

$$\frac{{V}_{cv}}{{I}_{cc}} = ω M \qquad ( 4 )$$

$$\frac{{V}_{cv}}{{I}_{cc}} = ω {L}_{r} \qquad ( 5 )$$

where V_{cv} is an effective value of an output constant voltage.

Further, depending on the different structure, voltage transformation ratio of Structure I can be calculated by Formula (6), voltage transformation ratio of Structure II can be calculated by Formula (7):

$$\frac{{V}_{out}}{{V}_{in}} = 1.35 \frac{M}{{L}_{r}} \qquad ( 6 )$$

$$\frac{{V}_{out}}{{V}_{in}} = 1.35 \frac{{L}_{r}}{M} \qquad ( 7 )$$

where Vₒᵤₜ is an output DC voltage on the load.

Further, the rectifier circuit is composed of two or four diodes;

Further, the diode is a SiC diode/a Si diode/a Schottky diode.

Further, the structure of the transmitting inductor L_{T} and the receiving inductor L_{R} is a wireless power transfer coil or a high-frequency magnetic core transformer.

The present invention also provides a design method of isolated DC power supply based on Class-E inverter, including the following steps:
S1. designing the values of input voltage Vᵢₙ, output voltage Vₒᵤₜ, maximum power Pₘₐₓ, and system operating angular frequency ω as required; determining the value of a self-inductor and the mutual inductor of a transmitting port and a receiving port according to a physical structure of a selected transmission medium;
S2. depending on the different structure, determining values of the network inductor Lᵣ according to Formula (6) or Formula (7);
S3. determining values of the network capacitor Cᵣ, the receiving capacitor C_{R}, and the transmitting capacitor Cᵣ according to the system operating angular frequency ω, and the calculation expression is as follows:

$${C}_{r} = \frac{1}{{ω}^{2} {L}_{r}} \qquad ( 8 )$$

$${C}_{R} = \frac{1}{{ω}^{2} {L}_{R}} \qquad ( 9 )$$

$${C}_{T} = \frac{1}{{ω}^{2} {L}_{T}} \qquad ( 10 )$$

S4. determining the input inductor Lₑ according to the maximum output power Pₘₐₓ of the system, and the calculation expression is as follows:

$${L}_{e} = 1.33 \frac{{V}_{in}^{2}}{ω {P}_{max}} \qquad ( 11 )$$

S5. determining values of the parallel capacitor C₀ according to the system operating angular frequency ω, the input inductor Lₑ, and the calculation expression is as follows:

$${C}_{0} = \frac{1}{{( 1.292 ω )}^{2} {L}_{e}} \qquad ( 12 )$$

The beneficial effects of the present invention are:
1) the isolated DC power supply based on Class-E inverter provided by the present invention uses the Class-E inverter to invert the DC power supply to the high-frequency AC power supply output, compared with the conventional Class-E inverter, the present invention makes the output of the Class-E inverter independent of the load through parameter design, so that the DC converter has a constant voltage output;
2) the isolated DC power supply based on Class-E inverter provided by the present invention can adopt the wireless power transfer coil or the high-frequency magnetic core transformer according to different use scenarios;
3) the isolated DC power supply based on Class-E inverter provided by the present invention adopts a Class-E inverter, uses fewer switching devices, and has lower cost and smaller volume in comparison;
4) the isolated DC power supply based on Class-E inverter provided by the present invention has strong working stability, and has advantages of high frequency, high efficiency and high-power density.

Additional advantages, objectives, and features of the present invention will be set forth in part in the description that follows and in part will become apparent to those having ordinary skill in the art upon examination of the following or may be learned from practice of the present invention. The objectives and other advantages of the present invention may be realized and attained by the following description.

### BRIEF DESCRIPTION OF THE DRAWINGS

FIG. 1 is a schematic diagram of a circuit configuration of the isolated DC power supply based on a Class-E inverter according to the present invention, which has two structures;

FIG. 2 is a flow chart of a parameter design method of the isolated DC power supply based on a Class-E inverter according to the present invention.

### DETAILED DESCRIPTION OF THE EMBODIMENTS

In order to make the objectives, the technical solutions, and the advantages of the present disclosure clearer, the following clearly and completely describes the technical solutions in embodiments of the present disclosure with reference to the embodiments in combination with the drawings of the present disclosure. Apparently, the described embodiments are only some but not all of the embodiments of the present disclosure. All other embodiments obtained by those of ordinary skill in the art based on the embodiments of the present disclosure without involving any creative effort shall fall within the scope of protection of the present disclosure.

The present invention will be further elaborated hereafter in conjunction with accompanying drawings and embodiments.

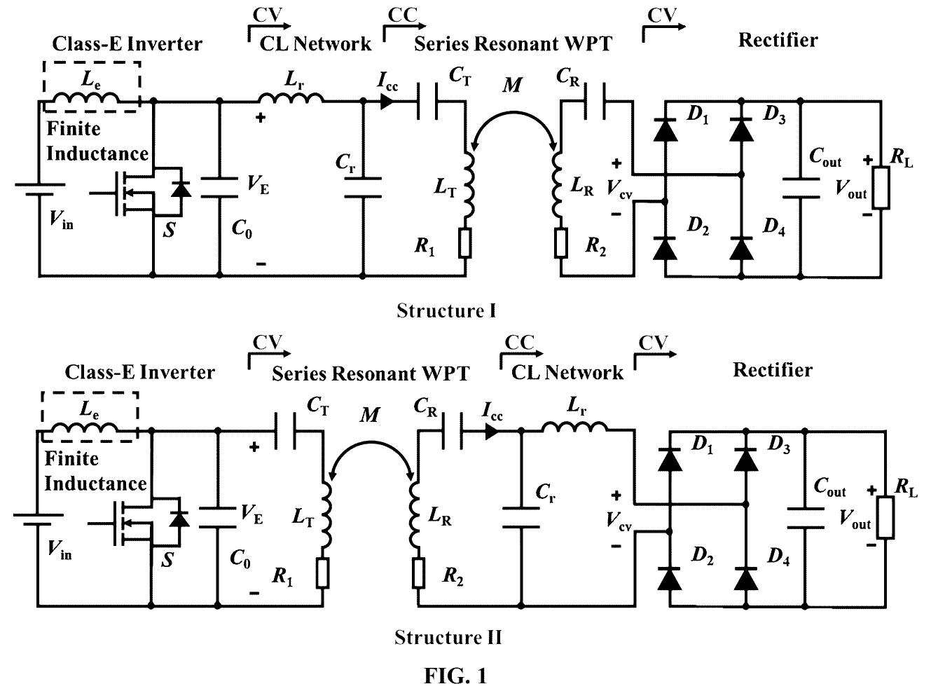

As shown in FIG. 1, the present invention provides an isolated DC power supply based on Class-E inverter, including a DC power supply, a Class-E inverter, a CL network, a series resonant unit, and a rectifier circuit, and it has two structures;

The Class-E inverter includes an input inductor Lₑ, a power switching device S, and a parallel capacitor C₀. Wherein, the value of Lₑ can be selected but not limited to 1 nH-100 μH, the value of Lₑ is 0.95 μH in this embodiment case, the value of C₀ can be selected but not limited to 10 pF-100 μF, the value of C₀ is 15.97 nF in this embodiment case, the switching S can be selected a SiC device or a GaN device, and the switching device is GaN devices in this embodiment case.

The CL network includes a network inductor Lᵣ and a network capacitor Cᵣ. Wherein, the values of Lᵣ can be selected but not limited to 1 nH-1 mH, the value of Lᵣ is 1.67 μH in this embodiment, and the value of Cᵣ can be selected but not limited to 10 pF-10 μF, the value of Cᵣ is 15.50 nF in this embodiment,

The series resonant unit includes a transmitting inductor L_{T}, a transmitting capacitor C_{T}, a transmitting inductor parasitic resistance R₁, a receiving inductor L_{R}, a receiving capacitor C_{R}, a receiving inductor parasitic resistance R₂, and M is a mutual inductor between the transmitting inductor L_{T} and the receiving inductor L_{R}. Wherein, the values of L_{T} and L_{R} can be selected but not limited to 1 nH-1 mH, the value of L_{T} is 4.80 μH in this embodiment and the value of L_{R} is 4.80 μH in this embodiment, the values of M can be selected but not limited to 10 nH-1 mH, the value of M is 1.70 μH in this embodiment, the value of C_{T} can be selected but not limited to 10 pF-10 μF, the value of C_{T} is 5.5 nF in this embodiment, the value of C_{R} can be selected but not limited to 10 pF-10 μF, the value of C_{R} is 5.5 nF in this embodiment, the values of R₁ and R₂ can be selected but not limited to 0.01Ω-10Ω, the values of R₁ and R₂ are 0.45Ω in this embodiment.

The rectifier circuit includes a rectifier circuit and a filter capacitor Cₒᵤₜ, wherein, the rectifier circuit is composed of two or four diodes, the rectifier diode can choose SiC diode, Si diode, or Schottky diode, four rectifier diodes D₁-D₄ are Schottky diodes in this embodiment; the value of filter capacitor Cₒᵤₜ can be selected but not limited to 10 pF-10 mF, the value of Cₒᵤₜ is 30 μF in this embodiment, and the rectifier circuit can rectify the high-frequency AC to the DC required by the load R_{L}.

According to the above parameters, two kinds of structures can be formed as shown in FIG. 1, the two structures include:
Structure I: an input port of the Class-E inverter is connected to the DC power supply, an output port of the Class-E inverter is connected to an input port of the CL network, an output port of the CL network is connected to an input port of the series resonant unit, an output port of the series resonant unit is connected to an input port of the rectifier circuit, an output port of the rectifier circuit is connected to a load;
Structure II: an input port of the Class-E inverter is connected to the DC power supply, an output port of the Class-E inverter is connected to an input port of the series resonant unit, an output port of the series resonant unit is connected to an input port of the CL network, an output port of the CL network is connected to an input port of the rectifier circuit, an output port of the rectifier circuit is connected to a load.

The Class-E inverter can invert the DC into the high-frequency AC with constant voltage output, and its transformation ratio can be calculated by Formula (1):

$$\frac{{V}_{E}}{{V}_{in}} = 1.124 \qquad ( 1 )$$

where Vᵢₙ is a voltage of an input DC power supply, and V_{E} is an effective value of an output high-frequency AC.

Depending on the different structure, the CL network or the series resonant unit can convert the high-frequency AC with a constant voltage output of the Class-E inverter into a constant current output, and transformation ratio of Structure I can be calculated by Formula (2), transformation ratio of Structure II can be calculated by Formula (3):

$$\frac{{I}_{cc}}{{V}_{E}} = \frac{1}{ω {L}_{r}} \qquad ( 2 )$$

$$\frac{{I}_{cc}}{{V}_{E}} = \frac{1}{ω M} \qquad ( 3 )$$

where I_{cc} is an effective value of a high-frequency output current, ω is an operating angular frequency.

Depending on the different structure, series resonant unit or the CL network can convert the constant current input into a constant voltage output, and transformation ratio of Structure I can be calculated by Formula (4), transformation ratio of Structure II can be calculated by Formula (5):

$$\frac{{V}_{cv}}{{I}_{cc}} = ω M \qquad ( 4 )$$

$$\frac{{V}_{cv}}{{I}_{cc}} = ω {L}_{r} \qquad ( 5 )$$

where V_{cv} is an effective value of an output constant voltage.

The isolated DC power supply based on Class-E inverter can obtain a voltage transformation ratio that can be selected but not limited to 0.1-50 by adjusting the size of Lᵣ and M, the output voltage Vₒᵤₜ does not change with the load R_{L}, the voltage transformation ratio is 1.35 in this embodiment, the input voltage Vᵢₙ can be selected but not limited to 0.1V-10 kV, the value of Vᵢₙ is 10V in this embodiment, the output voltage Vₒᵤₜ can be selected but not limited to 0.1V-10 kV, the value of Vₒᵤₜ is 13.5V in this embodiment, and the maximum power Pₘₐₓ can be selected but not limited to 1 W-10 kW, the value of Pₘₐₓ is 8 W in this embodiment, the system operating angular frequency ω can be selected but not limited to 2π×100 kHz-2π×10 MHz, and the value of ω is 2π×1 MHz in this embodiment.

The isolated DC power supply based on Class-E inverter, depending on the different structure, voltage transformation ratio of Structure I can be calculated by Formula (6), voltage transformation ratio of Structure II can be calculated by Formula (7):

$$\frac{{V}_{out}}{{V}_{in}} = 1.35 \frac{M}{{L}_{r}} \qquad ( 6 )$$

$$\frac{{V}_{out}}{{V}_{in}} = 1.35 \frac{{L}_{r}}{M} \qquad ( 7 )$$

where Vₒᵤₜ is an output DC voltage on the load.

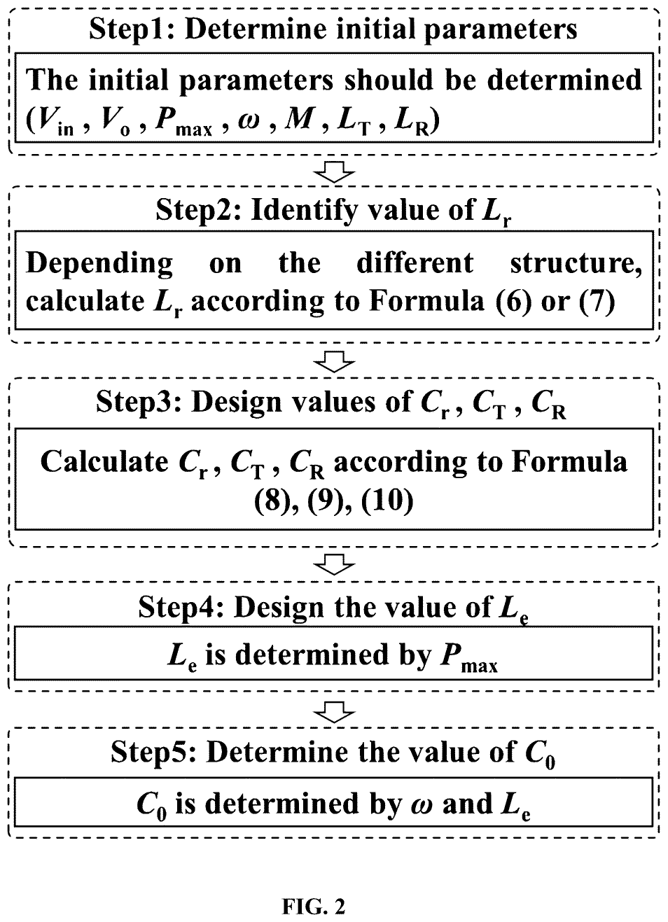

As shown in FIG. 2, the present invention also provides a design method of isolated DC power supply based on Class-E inverter, including the following steps:
S1. the values of input voltage Vᵢₙ, output voltage Vₒᵤₜ, maximum power Pₘₐₓ, and system operating angular frequency ω are designed as required; the value of a self-inductor and the mutual inductor of a transmitting port and a receiving port are determined according to a physical structure of a selected transmission medium;
S2. depending on the different structure, determining value of the network inductor Lᵣ according to Formula (6) or Formula (7);
S3. determining values of the network capacitor Cᵣ, the receiving capacitor C_{R}, and the transmitting capacitor C_{T} according to the system operating angular frequency ω, and the calculation expression is as follows:

$${C}_{r} = \frac{1}{{ω}^{2} {L}_{r}} \qquad ( 8 )$$

$${C}_{R} = \frac{1}{{ω}^{2} {L}_{R}} \qquad ( 9 )$$

$${C}_{T} = \frac{1}{{ω}^{2} {L}_{T}} \qquad ( 10 )$$

S4. determining the input inductor Lₑ according to the maximum output power Pₘₐₓ of the system, and the calculation expression is as follows:

$${L}_{e} = 1.33 \frac{{V}_{in}^{2}}{ω {P}_{max}} \qquad ( 11 )$$

S5. determining values of the parallel capacitor C₀ according to the system operating angular frequency ω, and the input inductor Lₑ and the calculation expression is as follows:

$${C}_{0} = \frac{1}{{( 1.292 ω )}^{2} {L}_{e}} \qquad ( 10 )$$

In summary, the isolated DC power supply based on Class-E inverter proposed in this invention has the advantages of constant voltage output not affected by load R_{L} change, high isolation voltage, high efficiency and low cost, and it has value of popularization and application in the field of power electronics and high voltage technology.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. An isolated DC power supply based on Class-E inverter, including a DC power supply, a Class-E inverter, a CL network, a series resonant unit, and a rectifier circuit, and it has two structures;
the Class-E inverter includes an input inductor Lₑ, a power switching device S, and a parallel capacitor C₀;
the CL network includes a network inductor Lᵣ and a network capacitor Cᵣ;
the series resonant unit includes a transmitting inductor L_{T}, a transmitting capacitor C_{T}, a transmitting inductor parasitic resistance R₁, a receiving inductor L_{R}, a receiving capacitor C_{R}, a receiving inductor parasitic resistance R₂, and M is a mutual inductor between the transmitting inductor L_{T} and the receiving inductor L_{R};
the rectifier circuit includes a rectifier circuit and a filter capacitor Cₒᵤₜ, and the rectifier circuit can rectify the high-frequency AC to the DC required by the load;
the two structures include:
Structure I: an input port of the Class-E inverter is connected to the DC power supply, an output port of the Class-E inverter is connected to an input port of the CL network, an output port of the CL network is connected to an input port of the series resonant unit, an output port of the series resonant unit is connected to an input port of the rectifier circuit, an output port of the rectifier circuit is connected to a load;
Structure II: an input port of the Class-E inverter is connected to the DC power supply, an output port of the Class-E inverter is connected to an input port of the series resonant unit, an output port of the series resonant unit is connected to an input port of the CL network, an output port of the CL network is connected to an input port of the rectifier circuit, an output port of the rectifier circuit is connected to a load.

2. The isolated DC power supply based on Class-E inverter according to claim 1, the value of the input inductor Lₑ is 1 nH-500 μH.

3. The isolated DC power supply based on Class-E inverter according to claim 1, the Class-E inverter can invert the DC into the high-frequency AC with constant voltage output, and its transformation ratio can be calculated by Formula (1):
$$\frac{{V}_{E}}{{V}_{in}} = 1.124 \qquad ( 1 )$$
where Vᵢₙ is a voltage of an input DC power supply, and V_{E} is an effective value of an output high-frequency AC.

4. The isolated DC power supply based on Class-E inverter according to claim 1, depending on the different structure, the CL network or the series resonant unit can convert the high-frequency AC with a constant voltage output of the Class-E inverter into a constant current output, and transformation ratio of Structure I can be calculated by Formula (2), transformation ratio of Structure II can be calculated by Formula (3):
$$\frac{{I}_{cc}}{{V}_{E}} = \frac{1}{ω {L}_{r}} \qquad ( 2 )$$
$$\frac{{I}_{cc}}{{V}_{E}} = \frac{1}{ω M} \qquad ( 3 )$$
where I_{cc} is an effective value of a high-frequency output current, ω is an operating angular frequency.

5. The isolated DC power supply based on Class-E inverter according to claim 1, depending on the different structure, series resonant unit or the CL network can convert the constant current input into a constant voltage output, and transformation ratio of Structure I can be calculated by Formula (4), transformation ratio of Structure II can be calculated by Formula (5):
$$\frac{{V}_{cv}}{{I}_{cc}} = ω M \qquad ( 4 )$$
$$\frac{{V}_{cv}}{{I}_{cc}} = ω {L}_{r} \qquad ( 5 )$$
where V_{cv} is an effective value of an output constant voltage.

6. The isolated DC power supply based on Class-E inverter according to claim 1, depending on the different structure, voltage transformation ratio of Structure I can be calculated by Formula (6), voltage transformation ratio of Structure II can be calculated by Formula (7):
$$\frac{{V}_{out}}{{V}_{in}} = 1.35 \frac{M}{{L}_{r}} \qquad ( 6 )$$
$$\frac{{V}_{out}}{{V}_{in}} = 1.35 \frac{{L}_{r}}{M} \qquad ( 7 )$$
where Vₒᵤₜ is an output DC voltage on the load.

7. The isolated DC power supply based on Class-E inverter according to claim 1, the rectifier circuit is composed of two or four diodes.

8. The isolated DC power supply based on Class-E inverter according to claim 7, the diode is a SiC diode/a Si diode/a Schottky diode.

9. The isolated DC power supply based on Class-E inverter according to claim 1, the structure of the transmitting inductor L_{T} and the receiving inductor L_{R} is a wireless power transfer coil or a high-frequency magnetic core transformer.

10. A design method of isolated DC power supply based on Class-E inverter according to claim 1, including the following steps:
S1. designing the values of input voltage Vᵢₙ, output voltage Vₒᵤₜ, maximum power Pₘₐₓ, and system operating angular frequency ω as required; determining the value of a self-inductor and the mutual inductor of a transmitting port and a receiving port according to a physical structure of a selected transmission medium;
S2. depending on the different structure, determining value of the network inductor Lᵣ according to Formula (6) or Formula (7);
S3. determining values of the network capacitor Cᵣ, the receiving capacitor C_{R}, and the transmitting capacitor Cᵣ according to the system operating angular frequency ω, and the calculation expression is as follows:
$${C}_{r} = \frac{1}{{ω}^{2} {L}_{r}} \qquad ( 8 )$$
$${C}_{R} = \frac{1}{{ω}^{2} {L}_{R}} \qquad ( 9 )$$
$${C}_{T} = \frac{1}{{ω}^{2} {L}_{T}} \qquad ( 10 )$$
S4. determining the input inductor Lₑ according to the maximum output power Pₘₐₓ of the system, and the calculation expression is as follows:
$${L}_{e} = 1.33 \frac{{V}_{in}^{2}}{ω {P}_{max}} \qquad ( 11 )$$
S5. determining values of the parallel capacitor C₀ according to the system operating angular frequency ω, and the input inductor Lₑ, and the calculation expression is as follows:
$${C}_{0} = \frac{1}{{( 1.292 ω )}^{2} {L}_{e}} . \qquad ( 12 )$$
